(19) United States
(12) Patent Application Publication
(10) Pub. No.: US 2015/0323122 A1
(43) Pub. Date: Nov. 12, 2015

(54) Platform Lift

(71) Applicant: Stewart E. Gardner, Bristol, IN (US)

(72) Inventor: Stewart E. Gardner, Bristol, IN (US)

(73) Assignee: R-N-R International, Inc., Bristol, IN (US)

(21) Appl. No.: 14/274,659

(22) Filed: May 9, 2014

(51) Int. Cl. F16M 11/18

(52) U.S. Cl. CPC F16M 11/18

(57) ABSTRACT

A platform lift employs flexible polyurethane timing belts as flexible rack members in a rack and pinion type drive mechanism. The platform lift includes a horizontal platform or deck shiftably mounted to a frame upright, post or column that is raised and lowered by movement of a “drive” carriage shiftably disposed within the frame upright. The carriage is driven along the flexible polyurethane timing belt disposed within the frame upright by a reversible electric motor that turns the pinion gear inside the carriage. The timing belt passes through a carriage and is trained around the pinion and between two idle rollers in a serpentine fashion.

This invention relates to a lift mechanism for raising and lowering platforms within a structure, such as a recreational vehicle or trailer.

### BACKGROUND AND SUMMARY OF THE INVENTION

Recreational vehicles, fifth wheel and cargo trailers often have automated lifts that raise and lower decks and platforms from a storage position for use as a bed, storage area or equipment lift within their interior space. While these automated lifts are popular and have convenient features, the mechanisms used to raise and lower the platforms have heretofore suffered from a variety of operational and manufacturing problems. An array of hydraulic, pneumatic and electro-mechanical actuation devices (“actuators”) have been employed with varying degrees of success, including screw drives, chains, rack and pinions, telescoping rams, as well as various linkage arrangements.

The present invention provides a platform lift that employs flexible polyurethane timing belts as flexible rack members in a rack and pinion type drive mechanism. Each embodiment of the platform lift includes a horizontal platform or deck shiftably mounted to a frame upright, post or column that is raised and lowered by movement of a “drive” carriage shiftably disposed within the frame upright. The carriage is driven along the flexible polyurethane timing belt disposed within the frame upright by a reversible electric motor that turns the pinion gear inside the carriage. The timing belt passes through a carriage and is trained around the pinion and between two idle rollers in a serpentine fashion.

The flexibility of the timing belt and the serpentine engagement of the timing belt around the idle rollers and the pinion ensures positive actuation of the platform between its raised and lowered positions and eliminates the chance of slippage. The use of a flexible timing belt also provides manufacturing and maintenance advantages. Because timing belts are durable, resist stretch and require little lubrication, the actuator of this invention requires little care or maintenance once installed. The timing belts are easily mounted and readily accessible inside the frame upright. The reduced weight of the timing belts over traditional rigid metal racks means smaller and less costly drive motors and components can be used.

These and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a perspective view of a bed lift that depicts an embodiment this invention shown in the lowered position;

FIG. 2 is a perspective view of the bed lift of FIG. 1 shown in the raised position;

FIG. 3 a partial perspective view with a portion cut away of the actuator mechanism used in the bed lift of FIG. 1;

FIG. 4 is a side sectional view of the “driven” slide carriage used in the bed lift of FIG. 1;

FIG. 5 is a top sectional view of the “driven” slide carriage and motor assembly used in the bed lift of FIG. 1;

FIG. 6 is a partial perspective view with a portion cut away of the alignment mechanism used in the bed lift of FIG. 1;

FIG. 7 is a side view of a platform lift that depicts a second embodiment of this invention shown in the lowered position; and

FIG. 8 is a side view of a platform lift that depicts a second embodiment of this invention shown in the raised position.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical and material composition changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

The drawings depict multiple embodiments of the platform lift of this invention. Each embodiment adapted for a particular application, such as a bed lift in recreational vehicles, a wheel chair lift for handi-capable vehicles or platform lift for raising motorcycles and ATVs into cargo trailers and the like. In each embodiment of the platform lift, the horizontal platform or deck is shiftably mounted to a frame upright, post or column and raised and lowered by a rack and pinion type drive mechanism using a flexible polyurethane timing belt disposed within the frame upright as a flexible rack member. The deck or platform carried is by a motor drive traveler that traverses along the length of the timing belt to raise and lower the platform up and down the frame upright.

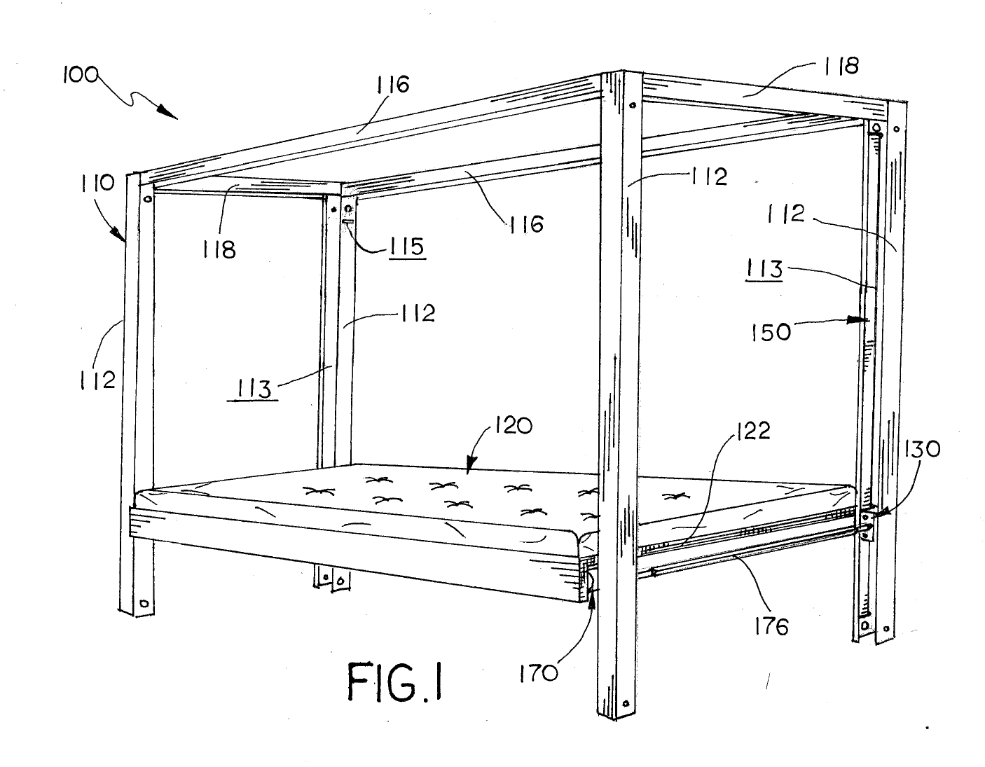

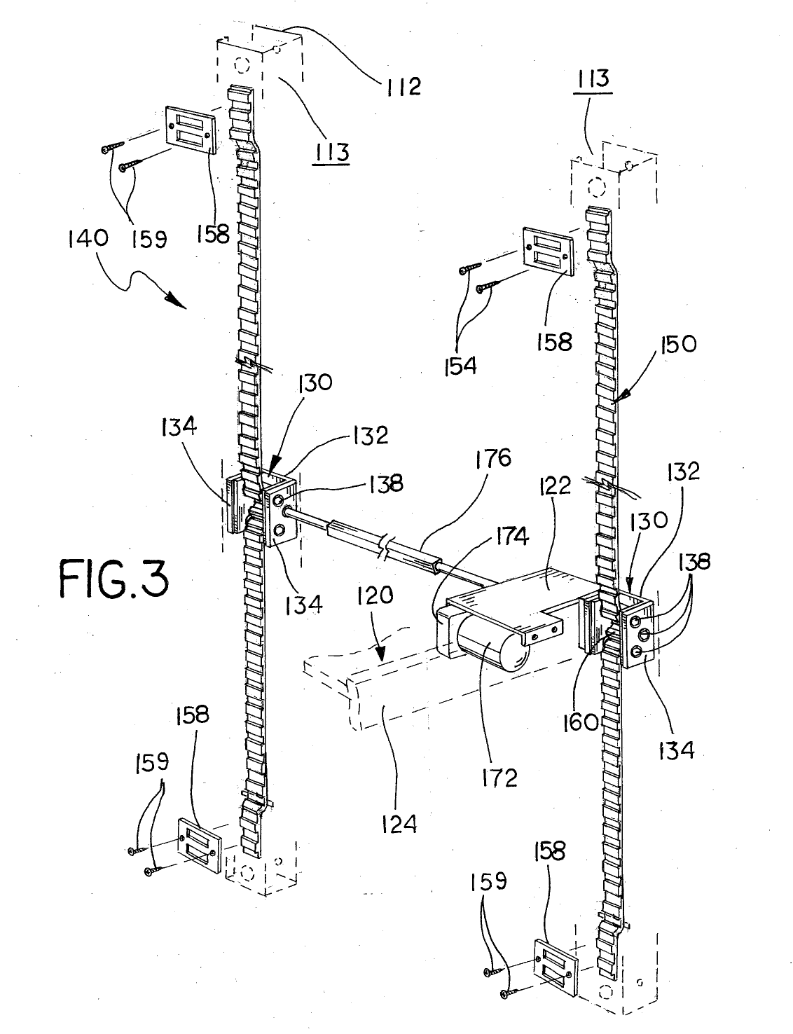

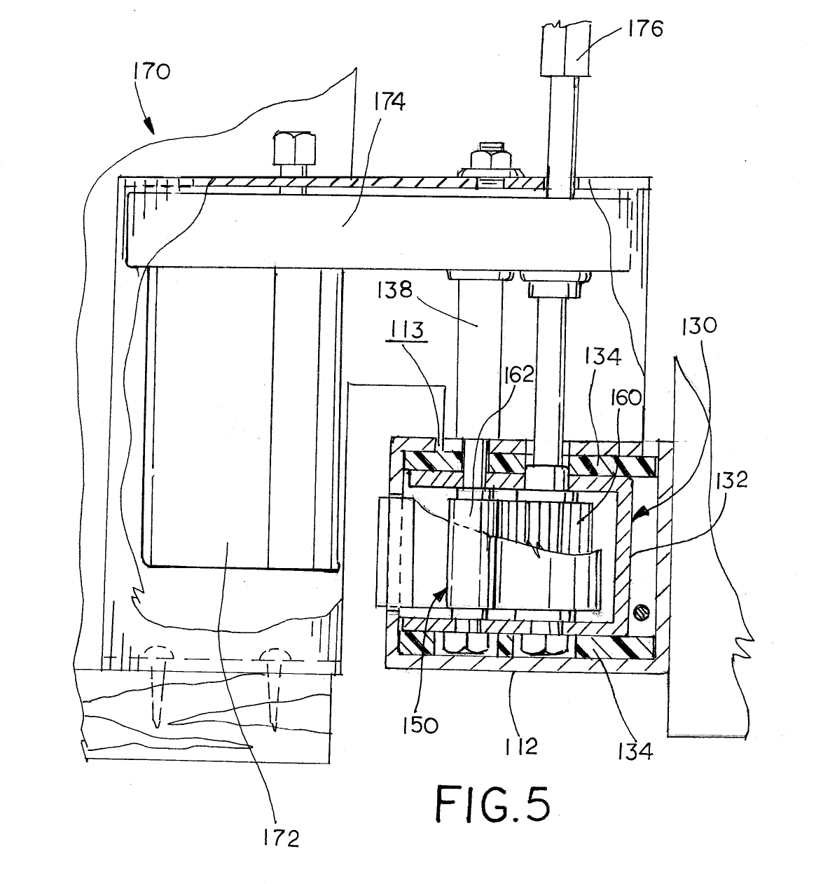

FIGS. 1-6 illustrate an embodiment of the platform lift of this invention in the form of a bed lift, which is designated generally as reference numeral 100. As shown, bed lift 100 is the type used in recreational vehicles, trailers or dwelling structures. While bed lift 100 is generally designed and intended for use in RVs and trailers, it may be modified for other purposes in other structures and applications.

As shown, bed lift 100 includes a support frame 110. Support frame 110 is generally built into the interior walls of the RV or trailer or otherwise fastened to the super structure of the RV or trailer. Alternatively, frame 110 may be modified in other embodiments to be a free standing structure within the living or working interior of an RV or trailer. Support frame 110 generally includes four upright corner columns or posts 112 and a pair of side cross members 116 and end cross members 118 each connecting the top ends of two corner posts. Corner posts 112 are generally affixed to the interior wall of the RV or trailer (not shown) by screws or similar fasteners. Corner posts 112 are lengths of metal C-channel, which have a hollow interior with an inward facing vertical channel 113. Side and end cross members 116 and 118 are lengths of square aluminum or steel tubing welded or fastened to the tops of corner posts 112.

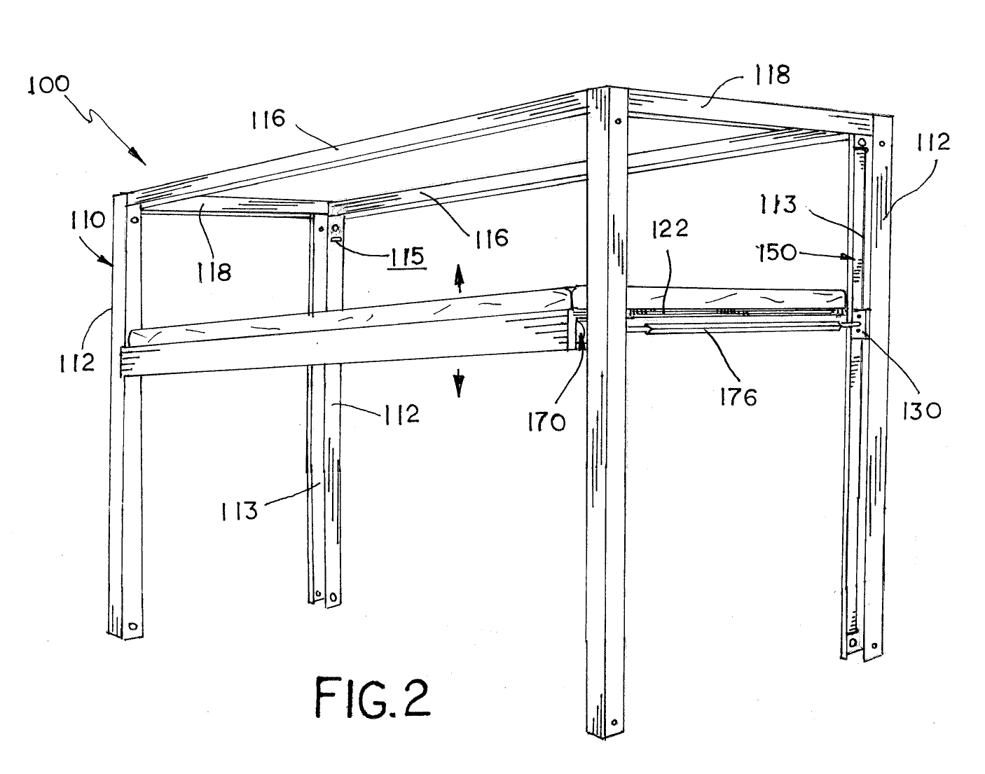

A bed deck 120 is suspended between corner posts 112 for movement between a lowered (FIG. 1) and raised position (FIG. 2). Bed deck 120 is designed to support a conventional mattress and/or box spring along with other bedding. Bed deck 120 is constructed of a sheet of plywood or similar material 122 seated atop a metal sub-frame 124. Bed frame 124 is supported atop four slide carriages 130 (two driven and two non-driven), which are shiftably disposed within corner posts 112. Each carriage 130 includes a U-shaped bracket 132 and a pair of low friction Teflon ® contact pads 134 that abut opposing inner walls of the corner posts 112 and allow smooth stable vertical movement of the carriage along the length of the corner posts. Alternative embodiment of the carriage may use bearing or roller in place of the contact blocks to facilitate low friction movement of the carriage within the corner posts. Each carriage 130 has one or more bolts 138 that extend from bracket 132 and protrude through channel 113 of corner posts 112. The protruding end of bolts 138 provide a support structure upon which bed frame 124 rests.

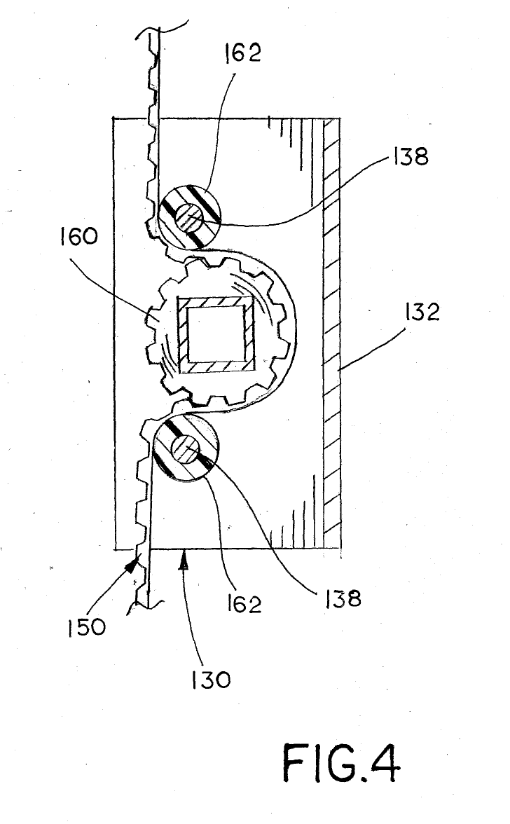

An actuator assembly 140 raises and lowers bed deck 120 between its raised position and lowered position. Actuator assembly 150 uses a flexible rack and pinion mechanism to vertically reciprocate two of the slide carriages 130 within adjacent corner posts 112. Actuator assembly 140 includes a pair of flexible polyurethane timing belts 150 mounting within the interior 111 of adjacent corner posts 112. Timing belts 150 act as a flexible rack member in a rack and pinion type drive mechanism. Timing belts 150 are of conventional design and construction, such as the kind manufactured and distributed by Polytech Design, Inc. Of Clifton, N.J. Timing belts 150 are used due to their strength, flexibility and stretch resistance. Polyurethane timing belts are also light weight, durable and require little lubrication. Although, steel reinforced polyurethane timing belts are preferred, any other light weight, durable, stretch resistant timing belt may be employed within the teaching of this invention. Each timing belt 150 has a plurality of raised teeth, which extend lateral across one face of the belt. Generally, timing belts 150 have imbedded reinforcing fibers (not shown), which prevent longitudinal stretch of the belts. Timing belts 150 extend through the interior of corner posts 112. The end of the belts pass through openings 115 at the ends of the corner posts and are secured to the outside of corner posts 112 by clamping plates 158 and fastener 159. As shown, clamping plates 158 allow for linear adjustment of the position of timing belts 150 relative to its position within corner post 112. With the ends affixed to the corner posts 112, timing belts 150 extends loosely through the interior of corner posts 112. Actuator assembly 140 uses two of slide carriages 130 acting as “drive” carriages operatively associated with timing belts 150 to raise and lower bed deck 120. While only two of the four slide carriages 130 are used in this embodiment as drive carriages, in other embodiments, all four side carriages may be used as “drive” carriages to raise and lower bed deck 120. The “drive” carriages 130 are similar in design and structure to the other slide carriages, but include a pinion 160 and two idle rollers 162 rotatably mounted within U-shaped bracket 132, which allows the carriage to be operatively propelled along the length of the timing belt 150. Timing belt 150 passes through drive carriage 130 and is trained around pinion 160 between two idle rollers 162 in a serpentine fashion. As shown in FIG. 4, idle rollers 162 position timing belt 150 to wrap partially around pinion 144 to ensure a tight positive engagement between timing belt 150 and pinion 160. Idle rollers 162 turn on bolt shafts 138 that protrude from bracket 132 and extend through channel 113 in corner posts 112. As with the non-driven slide carriages, the protruding ends of bolt shafts 138 provide a support structure for deck frame 122 to rest atop.

Actuator assembly 140 also includes an electric motor assembly 170, which drives pinion 160. Motor assembly 170 includes a reversible electric motor 172, gear box 174 and drive shaft 176. Motor 170 is a conventional reversible AC or DC electric motor although any suitable drive motor may be used as desired. Motor assembly 170 is mounted to the underside of deck frame 122 and turns drive shaft 156 to simultaneously drive pinions 160, which propel drive carriage 130 along the length of timing belts 150 thereby moving bed deck 120 between its raised and lowered positions. Motor 170 turns pinions 160 in one direction to raise deck 120 and in the opposite direction to lower the deck.

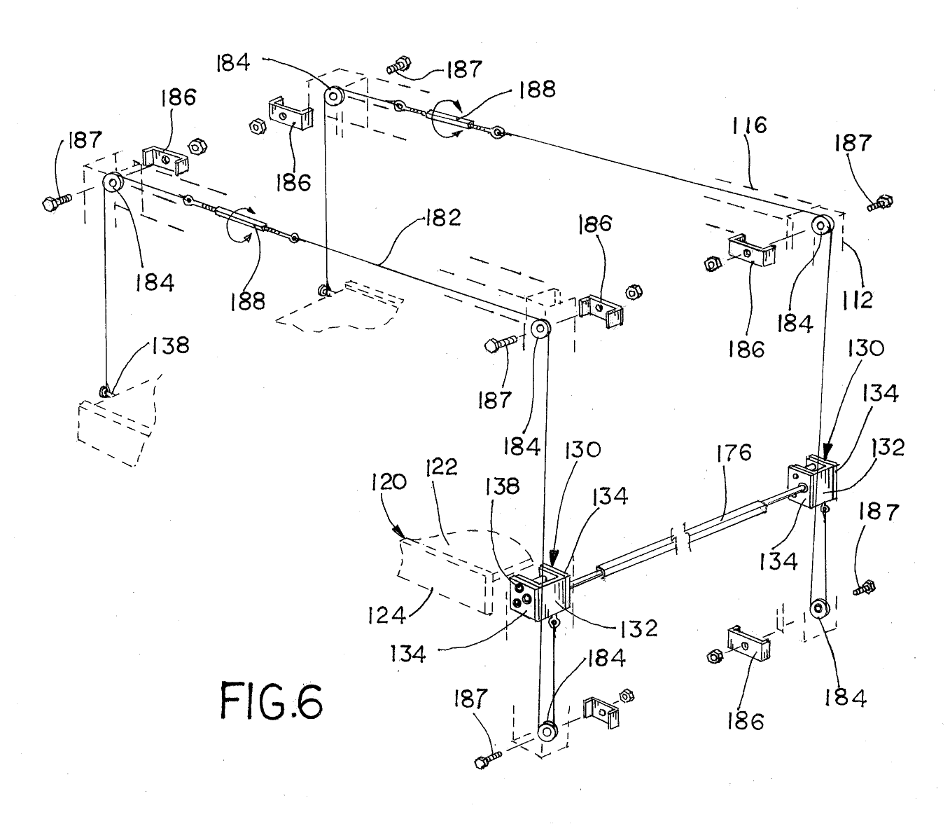

As best shown in FIG. 6, bed lift 100 also includes a platform alignment mechanism 180. Alignment mechanism 180 includes a pair of support wire cables 182 disposed within frame 110. Support cables 182 are trained about three sheaves 184 disposed within the corner posts 112 and extend through cross members 116 between adjacent corner posts 112. Sheaves 184 are mounted within corner posts by bracket 186 and bolt fasteners 187. The ends of each support cable 182 are connected to adjacent “drive” and “non-driven” slide carriages 130. The ends of support cables 182 are secured to slide carriages 130 to eye bolts 185, directly to bolts 138 or any other convenient structure of the slide carriages. Each support cable includes a turnbuckle 188 that allows the length of the support cable to be adjusted and thereby align and level platform 120 with respect to the frame. Turnbuckles 188 are generally disposed within cross members 116 and are accessible through an opening (not shown) in the cross member. Once properly adjusted with bed deck 120 level between corner posts 112, the support cables 182 work in conjunction to maintain the level orientation of the bed deck as it moves between its raised and lowered position.

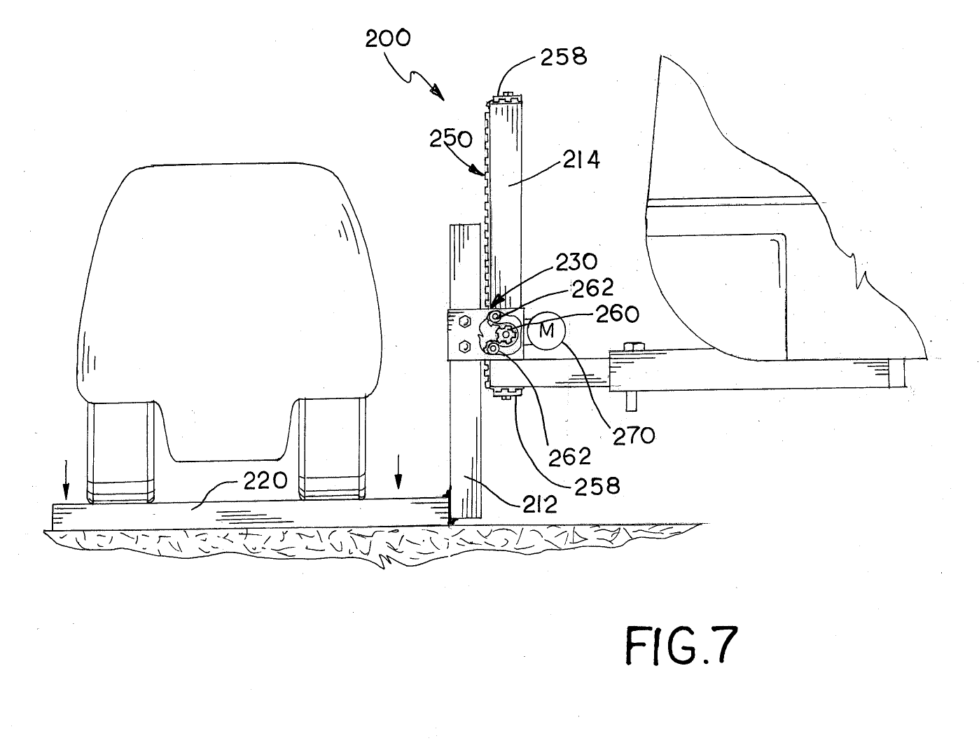

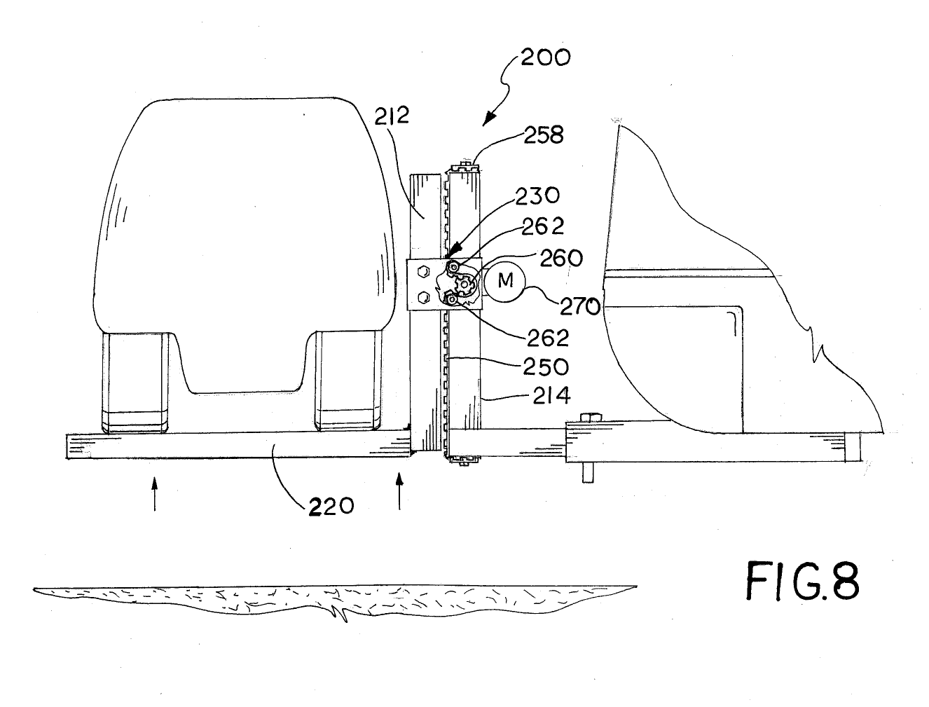

FIGS. 7 and 8 illustrate a second embodiment of this invention, which is depicted as a hitch mounted platform lift 200 for raising and lowering ATVs, motorcycles and other equipment. Again, platform lift 200 uses a flexible polyurethane timing belt as a flexible rack serpentined around a pinion gear and idle rollers in a rack and pinion style drive mechanism. As shown, platform lift includes a frame having two uprights 212 and 214, which slide vertically relative to each other. A carriage 230 shiftably couples uprights 212 and 214. Carriage 230 supports pinion 260 and idle rollers 262 within upright 214. Timing belt 250 is mounted to the side of upright 214 facing upright 212 by clamps 258 and serpentines around the pinion gear between the idle rollers. A reversible electric motor assembly 270 mounted to carriage 230 drives pinion 260 to propel the carriage along the length of upright 214, which raises and lowers the platform 220 mounted to upright 212.

The present invention provides several significant benefits over conventional platform lifts. In addition, the flexibility of the timing belts and the serpentine engagement of the timing belts around the idle rollers and pinion ensure positive actuation of the platform between its raised and lowered positions and eliminates the chance of slippage. The use of timing belts in the actuator of this invention also provides manufacturing and maintenance advantages in slide-out room applications. Because timing belts are durable, resist stretch and require little lubrication, the actuator of this invention requires little care or maintenance once installed. In the rare case that adjustment or replacements are needed, the majority of the actuator's components are readily accessible. The timing belts are easily mounted and readily accessible inside the frame uprights, column and corner posts. The mounting channels and clamping plates allow the slack timing belts to be quickly and readily tightened once operatively mated through the drive carriage. More importantly, the mounting channels and clamping plates allow for the adjustment of the timing belts relative to the column or corner post. The reduced weight of the timing belts over traditional rigid metal racks means smaller and less costly drive motors and components can be used.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A platform lift comprising:
an elongated frame upright having an interior therein and a longitudinal channel, the frame upright having a top end and bottom end thereof;
a platform shiftably mounted to the frame upright for vertical movement relative to the frame upright between a first position along the frame upright and a second position along the frame upright; and
an actuator for raising and lowering the platform between the first position and the second position, the actuator includes a flat flexible toothed belt mounted longitudinally within the frame upright between the top end of the frame upright and the bottom end of the frame upright, the belt having a first and second end, each of the first and second belt ends being spaced from the other and affixed to the frame upright, a carriage shiftably disposed within the frame upright for traverse movement along the length of the frame upright, the platform mounted to the carriage, the carriage includes a pinion and first and second idle rollers, the pinion being axially disposed between the first and second idle rollers, the belt being trained over the pinion between the first and second idle rollers in a serpentine fashion such that the belt partially wraps around the pinion in operative engagement therewith, and a motor operatively connected to the pinion for turning the pinion to reciprocally propel the carriage along the belt between the first and second belt ends to move the platform between the first position and the section position.

2. The actuator of claim 1 wherein the belt is a length of timing belt.

3. The actuator of claim 1 and a clamping plate for affixing each of the first and second belt ends to the frame upright where the first and second ends are selectively positioned and affixed between the mounting channel and the clamping plate so as to allow for linear adjustment of the position of the belt relative to the frame upright.

4. The platform lift of claim 1 and a second frame upright spaced from the first frame upright, the platform suspended between the first frame upright and the second upright.

5. The platform lift of claim 4 wherein and a second carriage is shiftably disposed within the second frame upright for traverse movement along the length of the second frame upright,

6. The platform lift of claim 5 and an alignment mechanism for maintaining the platform in a level horizontal orientation with respect to the first frame upright and the second frame upright.

7. A platform lift comprising:
a frame, the frame having a pair of uprights spaced parallel to each other, each of the pair of uprights having a hollow interior therein and a longitudinal channel, the frame upright having a top end and bottom end thereof;
a platform shiftably suspended between the pair of frame uprights for vertical movement relative to the frame upright between a first position relative to the pair of frame uprights and a second position relative to the pair of frame uprights; and
an actuator for raising and lowering the platform between the first position and the second position, the actuator includes a flat flexible toothed belt mounted longitudinally within each of the pair of frame uprights between the top end of each of the frame uprights and the bottom end of each of the frame uprights, each of the belts having a first and second end, each of the first and second belt ends being spaced from the other and affixed to the frame upright, a carriage shiftably disposed within each of the frame uprights for traverse movement along the length of the frame upright, the platform mounted to each of the carriages, each of the carriages includes a pinion and first and second idle rollers, the pinion being axially disposed between the first and second idle rollers, each of the belts being trained over the pinion between the first and second idle rollers in a serpentine fashion such that the belt partially wraps around the pinion in operative engagement therewith, and a motor operatively connected to the pinions of each of the carriages for turning the pinions to reciprocally propel each of the carriages along the belts between the first and second belt ends to move the platform between the first position and the section position.

8. The actuator of claim 7 wherein the belt is a length of timing belt.

9. The actuator of claim 7 and a clamping plate for affixing each of the first and second belt ends to the frame upright where the first and second ends are selectively positioned and affixed between the mounting channel and the clamping plate so as to allow for linear adjustment of the position of the belt relative to the frame upright.

10. The platform lift of claim 7 and an alignment mechanism for maintaining the platform in a level horizontal orientation with respect to the first frame upright and the second frame upright.
